(19) United States
(12) Patent Application Publication
(10) Pub. No.: US 2026/0318580 A1
(43) Pub. Date: Oct. 15, 2026

(54) HEAT PUMP CYCLE DEVICE

(71) Applicant: DENSO CORPORATION, Kariya-city (JP)

(72) Inventors: Atsushi YAMADA, Kariya-city (JP); Yukimasa SUZUKI, Kariya-city (JP); Yoshiki KATO, Kariya-city (JP); Yasuhiro YOKOO, Kariya-city (JP); Osamu YOKOYAMA, Kariya-city (JP); Kosuke SHIRATORI, Kariya-city (JP)

(21) Appl. No.: 19/467,903

(22) Filed: Feb. 3, 2026

(30) Foreign Application Priority Data
Feb. 6, 2025 (JP) 2025-018452

(51) Int. Cl. F25B 49/02; F25B 39/04; F25B 41/31

(52) U.S. Cl. CPC F25B 49/02; F25B 39/04; F25B 41/31; F25B 2400/04; F25B 2600/2501

(57) ABSTRACT

A heat pump cycle device includes a compressor for compressing refrigerant, a first condenser for condensing refrigerant by heat exchange with a heat medium, and a second condenser connected in parallel for condensing refrigerant by heat exchange with air. The device features a first valve that controls refrigerant flow from a branching section to the second condenser, and a second valve that restricts flow from a merging section to the second condenser. The merging section combines flow paths downstream of both condensers. An expansion valve decompresses and expands refrigerant supplied from the merging section, and an evaporator evaporates the refrigerant by heat exchange with air or the heat medium. A bypass flow path connects the flow from the first valve through the second condenser to the second valve, and from the evaporator outlet to the compressor suction port, enabling recovery of refrigerant and oil.

### CROSS REFERENCE TO RELATED APPLICATION

The present application is based on Japanese Patent Application No. 2025 018452 filed on Feb. 6, 2025, the entire disclosure of which is incorporated herein by reference.

### TECHNICAL FIELD

The present disclosure relates to a heat pump cycle device installed in a vehicle.

### BACKGROUND

A heat pump cycle device used in a thermal management system of a vehicle has a refrigerant flow path downstream of a compressor.

### SUMMARY

According to at least one embodiment, a heat pump cycle device includes a compressor that compresses a refrigerant. The device has a first condenser that condenses the refrigerant discharged from the compressor by exchanging heat between the refrigerant and a heat medium. A second condenser is connected in parallel with the first condenser and condenses the refrigerant discharged from the compressor by exchanging heat between the refrigerant and air. A first valve permits or restricts the flow of refrigerant from a branching section to the second condenser. The branching section divides the refrigerant discharged from the compressor into a flow path upstream of the first condenser and a flow path upstream of the second condenser. A second valve restricts the flow of refrigerant from a merging section to the second condenser. The merging section merges a flow path downstream of the first condenser and a flow path downstream of the second condenser. An expansion valve may be provided downstream of the merging section and decompresses and expands the refrigerant supplied from the merging section. An evaporator evaporates the refrigerant discharged from the expansion valve by exchanging heat between the refrigerant and air or the heat medium. A bypass flow path may connect a refrigerant flow path from the first valve through the second condenser to the second valve, and a refrigerant flow path from a refrigerant outlet port of the evaporator to a refrigerant suction port of the compressor, and recover the refrigerant and oil from the second condenser to the refrigerant suction port of the compressor.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a circuit diagram of a heat pump cycle device according to a first embodiment.

FIG. 2 is a circuit diagram illustrating a high load condition during cabin cooling and battery cooling operation in the heat pump cycle device according to the first embodiment.

FIG. 3 is a circuit diagram illustrating a low to medium load condition during the cabin cooling operation and the battery cooling operation in the heat pump cycle device according to the first embodiment.

FIG. 4 is a circuit diagram illustrating cabin heating operation in the heat pump cycle device according to the first embodiment.

FIG. 5 is a circuit diagram of a heat pump cycle device according to a second embodiment.

FIG. 6 is a circuit diagram of a heat pump cycle device according to a third embodiment.

FIG. 7 is a circuit diagram of a heat pump cycle device according to a first modification of the third embodiment.

FIG. 8 is a circuit diagram of a heat pump cycle device according to a second modification of the third embodiment.

FIG. 9 is a circuit diagram of a heat pump cycle device according to a fourth embodiment.

FIG. 10 is a circuit diagram of a heat pump cycle device according to a fifth embodiment.

### DETAILED DESCRIPTION

To begin with, examples of relevant techniques will be described.

Conventionally, heat pump cycle devices used in thermal management systems of vehicles are known.

A heat pump cycle device according to a comparative example has a configuration in which a refrigerant flow path downstream of a compressor branches, via a three-way valve, into a refrigerant flow path provided with a gas cooler and a refrigerant flow path in which a first condenser and a second condenser are arranged in series. That is, the refrigerant flow path provided with the gas cooler and the refrigerant flow path in which the first condenser and the second condenser are arranged in series are connected in parallel. The gas cooler described of the comparative example is an air-cooled condenser, the first condenser is a water-cooled condenser, and the second condenser is a heater core.

When this heat pump cycle device performs cabin cooling operation, it drives the three-way valve on the downstream side of the compressor to direct the high-pressure refrigerant discharged from the compressor into the refrigerant flow path provided with the gas cooler, and controls the system so that the refrigerant does not flow into the refrigerant flow path in which the first condenser and the second condenser are arranged in series. On the other hand, when this heat pump cycle device performs cabin heating operation, it drives the three-way valve to direct the high-pressure refrigerant discharged from the compressor into the refrigerant flow path in which the first condenser and the second condenser are arranged in series, and controls the system so that the refrigerant does not flow into the refrigerant flow path provided with the gas cooler.

The heat pump cycle device of the comparative example does not use the first condenser and the second condenser during cooling operation. In addition, during heating operation, the gas cooler (i.e., the air-cooled condenser) is not used. Therefore, in either the cooling operation or the heating operation, refrigerant and oil accumulate in the condenser that is not being used. As a result, if the amount of refrigerant circulating in the cycle becomes insufficient, the performance of cooling, heating, or battery cooling may decrease. Furthermore, if the amount of oil supplied to the compressor becomes insufficient, there is a risk that the compressor may lock up.

In contrast to the comparative example, according to a heat pump cycle device of the present disclosure, condensers are arranged in parallel and the heat pump cycle device is capable of preventing a shortage of refrigerant and oil circulating in the cycle.

According to one aspect of the present disclosure, a heat pump cycle device includes a compressor that compresses a refrigerant. The device has a first condenser that condenses the refrigerant discharged from the compressor by exchanging heat between the refrigerant and a heat medium. A second condenser is connected in parallel with the first condenser and condenses the refrigerant discharged from the compressor by exchanging heat between the refrigerant and air. A first valve permits or restricts the flow of refrigerant from a branching section to the second condenser. The branching section divides the refrigerant discharged from the compressor into a flow path upstream of the first condenser and a flow path upstream of the second condenser. A second valve restricts the flow of refrigerant from a merging section to the second condenser. The merging section merges a flow path downstream of the first condenser and a flow path downstream of the second condenser. An expansion valve is provided downstream of the merging section and decompresses and expands the refrigerant supplied from the merging section. An evaporator evaporates the refrigerant discharged from the expansion valve by exchanging heat between the refrigerant and air or the heat medium. A bypass flow path connects a refrigerant flow path from the first valve through the second condenser to the second valve, and a refrigerant flow path from a refrigerant outlet port of the evaporator to a refrigerant suction port of the compressor, and recovers the refrigerant and oil from the second condenser to the refrigerant suction port of the compressor.

According to this configuration, the flow of the refrigerant from the compressor to the second condenser is regulated by the first valve, and during operation using only the first condenser, the refrigerant and the oil accumulated in the first condenser can be recovered to the compressor via the bypass flow path. Therefore, during such operation, it is possible to prevent a shortage of the refrigerant and the oil circulating in the cycle. Accordingly, this heat pump cycle device can improve the performance of the air conditioning, heating, and battery cooling, and furthermore, can prevent the compressor from locking.

A reference numeral in parentheses attached to each component or the like indicates an example of correspondence between the component or the like and specific component or the like described in an embodiments below.

Hereinafter, embodiments of the present disclosure will be described with reference to the drawings. In the following embodiments, the same or equivalent parts are denoted by the same reference numerals as each other, and explanations will be provided to the same reference numerals.

### First Embodiment

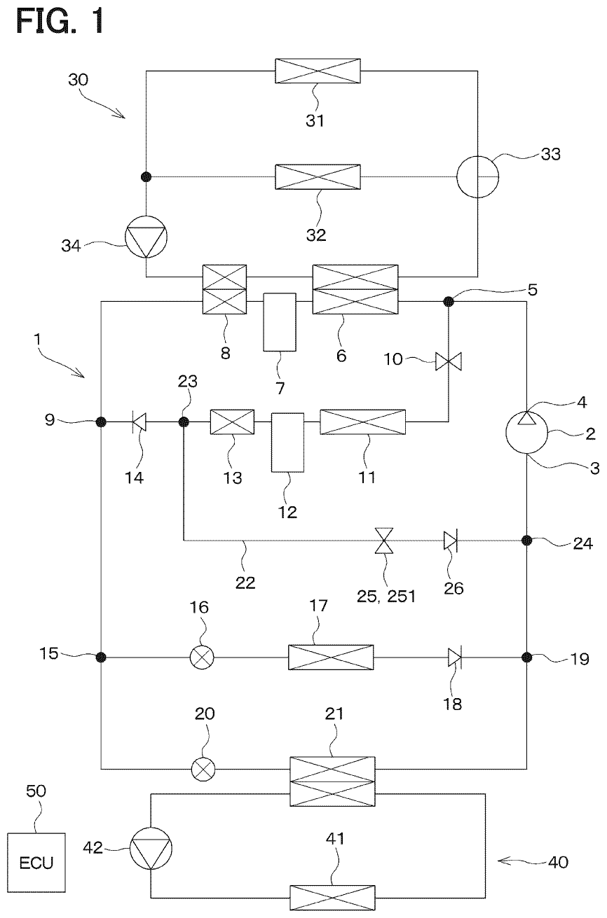

A first embodiment will be described with reference to FIGS. 1 to 4. A heat pump cycle device 1 according to the first embodiment is mounted on an electric vehicle or a hybrid vehicle, and is used for purposes such as cabin air conditioning and battery cooling.

First, a configuration of the heat pump cycle device 1 will be described. The heat pump cycle device 1 is a subcritical vapor compression refrigeration cycle in which a refrigerant pressure discharged from a compressor 2 does not exceed a critical pressure of refrigerant. As the refrigerant for the heat pump cycle device 1, for example, an HFO-type refrigerant such as R1234yf, or an HFC-type refrigerant such as R134a or R407C, is employed. The refrigerant is mixed with oil for lubricating the compressor 2. In the following description, the term “refrigerant” includes both the refrigerant itself and the oil.

As shown in FIG. 1, in the heat pump cycle device 1, components such as the compressor 2, a water-cooled condenser 6 (first condenser), an air-cooled condenser 11 (second condenser), expansion valves 16 and 20, and evaporators 17 and 21 are connected by refrigerant piping.

The compressor 2 is an electric compressor driven by electric power supplied from a battery. The compressor 2 compresses the refrigerant drawn in through a refrigerant suction port 3 and discharges it from a refrigerant discharge port 4. A rotational speed of the compressor 2 is controlled by an electronic control unit 50.

Downstream of the compressor 2, a first branching section 5 that branches a refrigerant flow path, and a first merging section 9 where two refrigerant flow paths branched at the first branching section 5 merge, are provided. The first branching section 5 corresponds to a branching section, and the first merging section 9 corresponds to a merging section. Of the two refrigerant flow paths connecting the first branching section 5 and the first merging section 9, the water-cooled condenser 6 or the like is provided in one refrigerant flow path, and the air-cooled condenser 11 or the like is provided in the other refrigerant flow path. Accordingly, in the heat pump cycle device 1, the water-cooled condenser 6 and the air-cooled condenser 11 are connected in parallel. In the following description, of the two refrigerant flow paths connecting the first branching section 5 and the first merging section 9, the refrigerant flow path in which the water-cooled condenser 6 or the like is provided is referred to as a water-cooled flow path, and the refrigerant flow path in which the air-cooled condenser 11 or the like is provided is referred to as an air-cooled flow path.

In the water-cooled flow path, the water-cooled condenser 6, a first liquid receiver 7, and a first subcooler 8 are provided in this order from the first branching section 5 side toward the first merging section 9 side.

The water-cooled condenser 6 is a heat exchanger that exchanges heat between the high-temperature, high-pressure gaseous refrigerant discharged from the compressor 2 and a heat medium circulating through a high-temperature circuit 30, which is a heat medium circuit on the high-temperature side. The water-cooled condenser 6 condenses the refrigerant and heats the heat medium. It should be noted that, as the heat medium circulating through the high-temperature circuit 30 on the high-temperature side, water or an antifreeze solution mainly composed of ethylene glycol or the like can be used.

Here, the high-temperature circuit 30 that supplies the heat medium to the water-cooled condenser 6 is provided with a radiator 31, a heater core 32, a three-way valve 33, a high-temperature pump 34, and the like. The radiator 31 is a heat exchanger that exchanges heat between the heat medium and an outside air of the vehicle compartment. The heater core 32 is provided in an air conditioning unit (not shown) and is a heat exchanger that exchanges heat between the heat medium and an air blown into the vehicle compartment. The heater core 32 is mainly used for heating the vehicle compartment. The three-way valve 33 switches a flow of the heat medium supplied to the radiator 31 and the heater core 32. The high-temperature pump 34 circulates the heat medium in the high-temperature circuit 30. The high-temperature pump 34 is a water pump.

Returning to the description of the heat pump cycle device 1, the first liquid receiver 7 provided on the downstream side of the water-cooled condenser 6 is a receiver tank that stores surplus refrigerant, which varies according to a load on the cycle. The first liquid receiver 7 separates the refrigerant flowing in from the water-cooled condenser 6 into a gaseous phase and a liquid phase, and only allows the liquid-phase refrigerant to flow downstream.

The first subcooler 8 is a heat exchanger that exchanges heat between the refrigerant discharged from the first liquid receiver 7 and the heat medium circulating in the high-temperature circuit 30. The first subcooler 8 increases a subcooling degree of the refrigerant and heats the heat medium.

On the other hand, in the air-cooled flow path, a first valve 10, the air-cooled condenser 11, a second liquid receiver 12, a second subcooler 13, and a second valve 14 are provided in this order from the first branching section 5 toward the first merging section 9.

The first valve 10 is provided in a middle part of the refrigerant flow path connecting the first branching section 5 and the air-cooled condenser 11, and has a function of permitting or restricting the flow of refrigerant from the first branching section 5 to the air-cooled condenser 11. More specifically, the first valve 10 is constituted by a solenoid valve. In the following description, the first valve 10 is referred to as an “air-cooling solenoid valve 10”.

The air-cooled condenser 11 is a heat exchanger that exchanges heat between the high-temperature, high-pressure gaseous refrigerant discharged from the compressor 2 and the outside air of the vehicle compartment. The air-cooled condenser 11 condenses the refrigerant.

The second liquid receiver 12 is a receiver tank that stores surplus refrigerant, which varies according to the load of the cycle. The second liquid receiver 12 separates the refrigerant flowing in from the air-cooled condenser 11 into a gaseous refrigerant and a liquid refrigerant, allowing only the liquid refrigerant to flow out to the downstream side. It should be noted that maximum storage capacity of the second liquid receiver 12 is equal to or less than maximum storage capacity of the first liquid receiver 7. It should be noted that, in this specification, “equal” means substantially the same, including manufacturing tolerances and the like.

The second subcooler 13 is a heat exchanger that performs heat exchange between the refrigerant discharged from the second liquid receiver 12 and the outside air of the vehicle compartment. The second subcooler 13 increases the subcooling degree of the refrigerant.

The second valve 14 is provided in a middle part of the refrigerant flow path connecting the second subcooler 13 and the first merging section 9. The second valve 14 has a function of allowing the flow of refrigerant from the second subcooler 13 side to the first merging section 9 side, and restricting the flow of refrigerant from the first merging section 9 side to the second subcooler 13 side. More specifically, the second valve 14 is constituted by a check valve. In the following description, the second valve 14 will be referred to as a “check valve 14 for air-cooled condenser.”

The air-cooled flow path and the water-cooled flow path, as described above, are configured such that a pressure loss of the refrigerant flowing through the air-cooled flow path is smaller than a pressure loss of the refrigerant flowing through the water-cooled flow path. Therefore, when the air-cooling solenoid valve 10 is opened and refrigerant is allowed to flow through both the air-cooled flow path and the water-cooled flow path, a flow rate of refrigerant through the air-cooled flow path becomes greater than a flow rate of refrigerant through the water-cooled flow path.

On the downstream side of the first merging section 9, a second branching section 15 that branches the refrigerant flow path, and a second merging section 19 where the two refrigerant flow paths branched at the second branching section 15 merge, are provided. Of the two refrigerant flow paths, an air conditioning evaporator 17 or the like is provided in one refrigerant flow path, while a battery evaporator 21 or the like is provided in the other refrigerant flow path.

In the refrigerant flow path of the air conditioning evaporator 17 side, a first expansion valve 16, the air conditioning evaporator 17, and a check valve 18 (third check valve) for the evaporator are provided in this order from the second branching section 15 side toward the second merging section 19 side.

The first expansion valve 16 reduces a pressure of and expands the refrigerant supplied from the water-cooled condenser 6 and the air-cooled condenser 11 side (i.e., the first merging section 9 side), thereby converting it into a low-temperature, low-pressure two-phase gas-liquid state and supplying it to the air conditioning evaporator 17. The first expansion valve 16 is constituted, for example, by a variable orifice such as a thermostatic expansion valve or an electrically operated expansion valve, or by a fixed orifice. The variable orifice is a mechanism that adjusts an opening area through which the refrigerant passes in the expansion valve according to a degree of superheat of the refrigerant on the outlet side of the air conditioning evaporator 17.

The air conditioning evaporator 17 is provided within the air conditioning unit, and serves as a heat exchanger that exchanges heat between the air blown into the vehicle compartment and the refrigerant supplied from the first expansion valve 16. The air conditioning evaporator 17 evaporates the refrigerant and cools the air. The air conditioning evaporator 17 is mainly used for cooling operation inside the vehicle compartment.

The check valve 18 for the evaporator allows the flow of refrigerant from the air conditioning evaporator 17 side toward the refrigerant suction port 3 of the compressor 2, and has a function of restricting the flow of refrigerant from the refrigerant suction port 3 of the compressor 2 toward the check valve 18 for the evaporator side.

On the other hand, in the refrigerant flow path on the battery evaporator 21 side, a second expansion valve 20 and a battery evaporator 21 are provided in this order from the second branching section 15 toward the second merging section 19.

The second expansion valve 20 depressurizes and expands the refrigerant supplied from the water-cooled condenser 6 and the air-cooled condenser 11 side (i.e., from the first merging section 9 side), converting it into a low-temperature, low-pressure two-phase (gas-liquid) state and supplying it to the battery evaporator 21. The second expansion valve 20 is constituted, for example, by a variable throttle such as a thermostatic expansion valve or an electrically operated expansion valve, or by a fixed throttle.

The battery evaporator 21 is a heat exchanger that exchanges heat between the refrigerant supplied from the second expansion valve 20 and the heat medium circulating in the low-temperature circuit 40, which is a low-temperature side heat medium circuit. The battery evaporator 21 evaporates the refrigerant and cools the heat medium. The battery evaporator 21 is also referred to as a chiller. As the heat medium circulating in the low-temperature circuit 40, water or an antifreeze having, for example, ethylene glycol as its main component can be used.

Here, the low-temperature circuit 40, which supplies the heat medium to the battery evaporator 21, is provided with components such as a battery cooler 41 and a low-temperature pump 42. The battery cooler 41 is a heat exchanger that exchanges heat between the battery installed in the vehicle and the heat medium. The low-temperature pump 42 circulates the heat medium through the low-temperature circuit 40. The low-temperature pump 42 is a water pump.

Returning to the description of the heat pump cycle device 1, the second merging section 19 is connected to the refrigerant suction port 3 of the compressor 2 via the refrigerant flow path. Therefore, the gas-phase refrigerant discharged from the air conditioning evaporator 17 and the battery evaporator 21 is drawn into the refrigerant suction port 3 of the compressor 2.

Furthermore, the heat pump cycle device 1 of the present embodiment is provided with a bypass flow path 22. The bypass flow path 22 is a passage for recovering refrigerant and oil from the air-cooled condenser 11 side to the refrigerant suction port 3 of the compressor 2. One end 23 of the bypass flow path 22 is connected to an intermediate point of the refrigerant flow path extending from the air-cooling solenoid valve 10, via the air-cooled condenser 11, up to the check valve 14 for the air-cooled condenser. On the other hand, the other end 24 of the bypass flow path 22 is connected to an intermediate point of the refrigerant flow path extending from a refrigerant outlet (refrigerant outlet port) of the air conditioning evaporator 17 to the refrigerant suction port 3 of the compressor 2, or to an intermediate point of the refrigerant flow path extending from a refrigerant outlet of the battery evaporator 21 to the refrigerant suction port 3 of the compressor 2. More specifically, in the first embodiment, one end 23 of the bypass flow path 22 is connected to an intermediate point of the refrigerant flow path that connects the second subcooler 13 and the check valve 14 for the air-cooled condenser. On the other hand, the other end 24 of the bypass flow path 22 is connected to an intermediate point of the refrigerant flow path that connects the second merging section 19 and the refrigerant suction port 3 of the compressor 2.

A flow control unit 25 and a check valve 26 (second check valve) for the bypass flow path 22 are provided in the bypass flow path 22. The flow control unit 25 has a function to control the flow of refrigerant in the bypass flow path 22. In the present embodiment, the flow control unit 25 is constituted by a solenoid valve capable of permitting and restricting the flow of refrigerant in the bypass flow path 22. In the following description, the flow control unit 25 constituted by a solenoid valve is referred to as a bypass solenoid valve 251.

The check valve 26 for the bypass flow path 22 allows the flow of refrigerant from the air-cooled condenser 11 side to the refrigerant suction port 3 side of the compressor 2, and is capable of restricting the flow of refrigerant from the refrigerant suction port 3 side of the compressor 2 to the air-cooled condenser 11 side.

The heat pump cycle device 1, the high-temperature circuit 30, and the low-temperature circuit 40 are driven and controlled by the electronic control unit 50. In the following description, the electronic control unit 50 is referred to as an ECU 50. ECU is an abbreviation for Electronic Control Unit. The ECU 50 includes a microcomputer or a microcontroller including a processor for performing control processing and arithmetic processing, a storage unit and a memory, such as a read only memory (i.e., ROM) and a random access memory (i.e., RAM), for storing a program and data, as well as peripheral circuits thereof. The storage unit or the memory include non-transitory tangible storage media or non-transitory tangible storage medium. The ECU 50 performs various control and arithmetic processing by having the processor execute programs stored in the storage unit or the memory. By executing programs stored in the storage unit or the memory, the processor implements methods corresponding to those programs. The ECU 50 controls operation of each device connected to an output side in accordance with programs stored on the storage unit or the memory, based on input information from various sensors and other inputs connected to the input side. More specifically, the ECU 50 controls the operation of the compressor 2, the air-cooling solenoid valve 10, the bypass solenoid valve 251, the high-temperature pump 34, the low-temperature pump 42, the three-way valve 33, and the like.

Next, the operation of the heat pump cycle device 1 will be described.

### High Load Condition During Cabin Cooling and Battery Cooling Operation

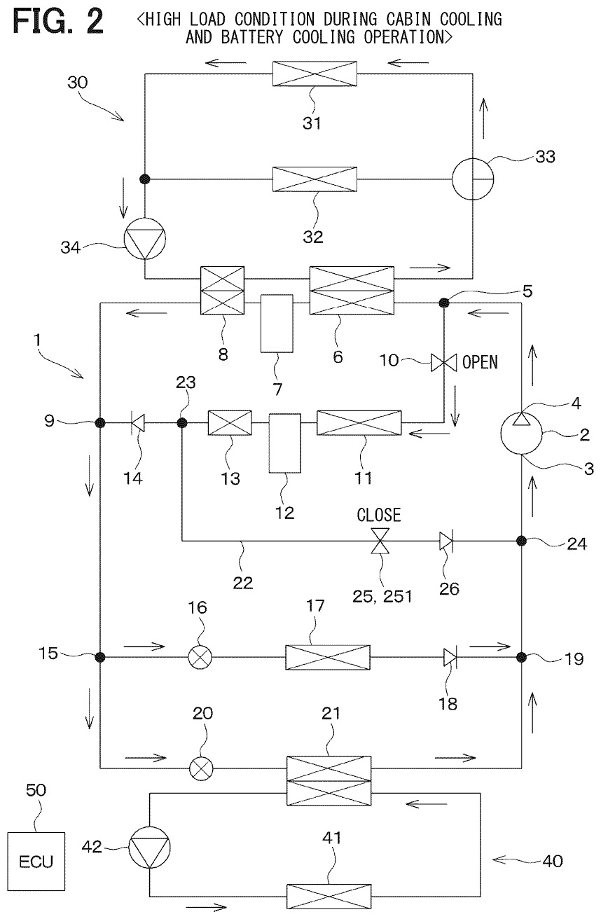

Under a high load condition during cabin cooling and battery cooling operation, the flows of the refrigerant and the heat medium are shown by an arrows in FIG. 2. The high load condition during cabin cooling operation and the battery cooling operation refers to a state in which the load of the cabin cooling operation and the battery cooling operation exceeds a predetermined load amount.

The ECU 50 determines that the high load condition exists when the rotational speed of the compressor 2 is equal to or greater than a predetermined rotational speed during the cabin cooling operation and the battery cooling operation. The predetermined rotational speed is set to an upper limit rotational speed or a rotational speed close to it. Alternatively, the ECU 50 may determine that the high load condition exists when a difference between a cabin set temperature and an outside air temperature is equal to or greater than a predetermined threshold. Additionally, the ECU 50 may determine that the high load condition exists when a difference between a target battery temperature and an actual battery temperature is equal to or greater than a predetermined threshold.

In the high load condition during cabin cooling operation and the battery cooling operation, the ECU 50 sets the rotational speed of the compressor 2 to a predetermined rotational speed or higher (for example, the upper limit rotational speed). Additionally, the ECU 50 opens the air-cooling solenoid valve 10 and closes the bypass solenoid valve 251. Furthermore, the ECU 50 drives the high-temperature pump 34 and the three-way valve 33 so that the heat medium circulating in the high-temperature circuit 30 flows through the radiator 31. Additionally, the ECU 50 drives the low-temperature pump 42.

As a result, as indicated by the arrows in FIG. 2, in the heat pump cycle device 1, the refrigerant discharged from the compressor 2 flows through both the refrigerant flow path on the water-cooled condenser 6 side and the refrigerant flow path on the air-cooled condenser 11 side. No refrigerant flows through the bypass flow path 22. In the high-temperature circuit 30, the heat medium circulates between the water-cooled condenser 6 and the radiator 31. In the low-temperature circuit 40, the heat medium circulates between the battery evaporator 21 and the battery cooler 41.

In this way, the heat pump cycle device 1 can significantly increase the heat dissipation of the high-pressure refrigerant by using both the water-cooled condenser 6 and the air-cooled condenser 11 under the high load conditions during cabin cooling operation and the battery cooling operation, thereby greatly improving air cooling performance and refrigerant cooling performance. Furthermore, in this heat pump cycle device 1, by connecting both the water-cooled condenser 6 and the air-cooled condenser 11 in parallel, the heat dissipation of the high-pressure refrigerant is increased, thereby greatly improving the air cooling performance and the refrigerant cooling performance using the evaporators 17 and 21.

It should be noted that, although the above describes high load conditions during cabin cooling operation and the battery cooling operation, the control by the ECU 50 is not limited thereto. For example, the ECU 50 may perform control to circulate refrigerant through both the air-cooled condenser 11 and the water-cooled condenser 6 when the load during the cabin cooling operation exceeds a predetermined amount, or when the load during battery cooling operation exceeds a predetermined amount.

### Low to Medium Load Conditions of Cabin Cooling and Battery Cooling Operation

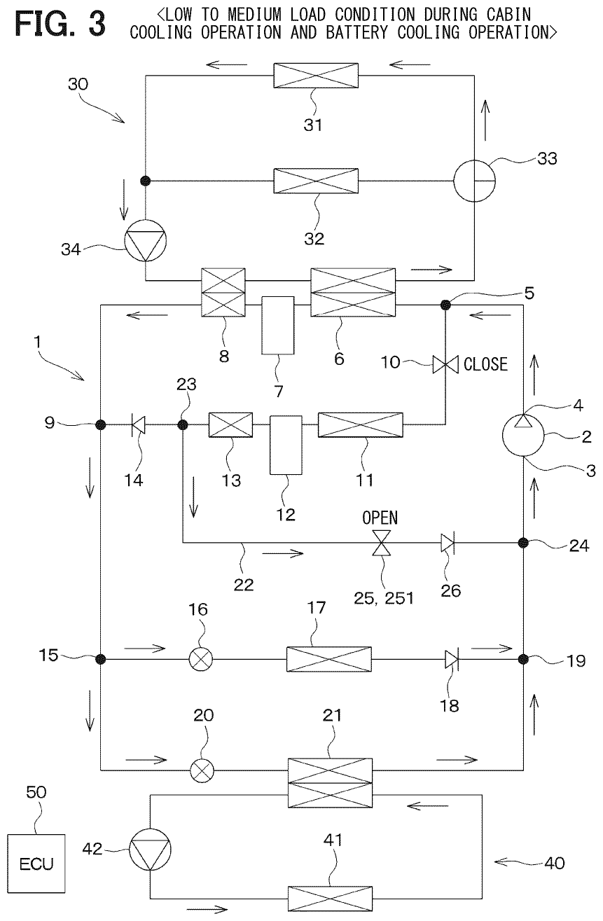

Under low to medium load conditions of the cabin cooling operation and the battery cooling operation, the flow of the refrigerant and the heat medium is indicated by an arrows in FIG. 3. The low to medium load conditions of the cabin cooling operation and the battery cooling operation refer to a state in which a load of the cabin cooling operation and the battery cooling operation is less than a predetermined amount.

The ECU 50 determines that the system is in the low to medium load conditions during the cabin cooling operation and the battery cooling operation when the rotational speed of the compressor 2 is below a predetermined value. Alternatively, the ECU 50 may determine that the system is in the low to medium load conditions when a difference between the cabin set temperature and the outside air temperature is less than a predetermined threshold. Further, the ECU 50 may determine that the system is in the low to medium load conditions when a difference between the target battery temperature and the actual battery temperature is less than a predetermined threshold.

In the low to medium load conditions of the cabin cooling operation and the battery cooling operation, the ECU 50 controls the rotational speed of the compressor 2 according to the cooling load and the battery cooling load, setting it to a rotational speed lower than a predetermined value (for example, lower than the upper limit speed). In addition, the ECU 50 closes the air-cooling solenoid valve 10 and opens the bypass solenoid valve 251. Furthermore, the ECU 50 drives the high-temperature pump 34 and the three-way valve 33, so that the heat medium circulating in the high-temperature circuit 30 flows through the radiator 31. In addition, the ECU 50 drives the low-temperature pump 42.

As a result, as indicated by the arrows in FIG. 3, in the heat pump cycle device 1, the refrigerant discharged from the compressor 2 flows through the refrigerant flow path on the water-cooled condenser 6 side, and does not flow through the refrigerant flow path on the air-cooled condenser 11 side. The refrigerant accumulated in the refrigerant flow path on the air-cooled condenser 11 side flows to the refrigerant suction port 3 of the compressor 2 via the bypass flow path 22. At that time, the refrigerant that has flowed out from the other end 24 of the bypass flow path 22 into the refrigerant flow path connecting the second merging section 19 and the refrigerant suction port 3 of the compressor 2 is mixed with the gas-phase refrigerant flowing through that refrigerant flow path, and is then drawn into the refrigerant suction port 3 of the compressor 2. It should be noted that, as described above, this refrigerant contains oil. In the high-temperature circuit 30, the heat medium circulates between the water-cooled condenser 6 and the radiator 31. In the low-temperature circuit 40, the heat medium circulates between the battery evaporator 21 and the battery cooler 41.

In this way, the heat pump cycle device 1 can reduce the power consumption of the compressor 2 by using only the water-cooled condenser 6 and not using the air-cooled condenser 11 during the low to medium load conditions of the cabin cooling operation and the battery cooling operation.

### Cabin Heating Operation

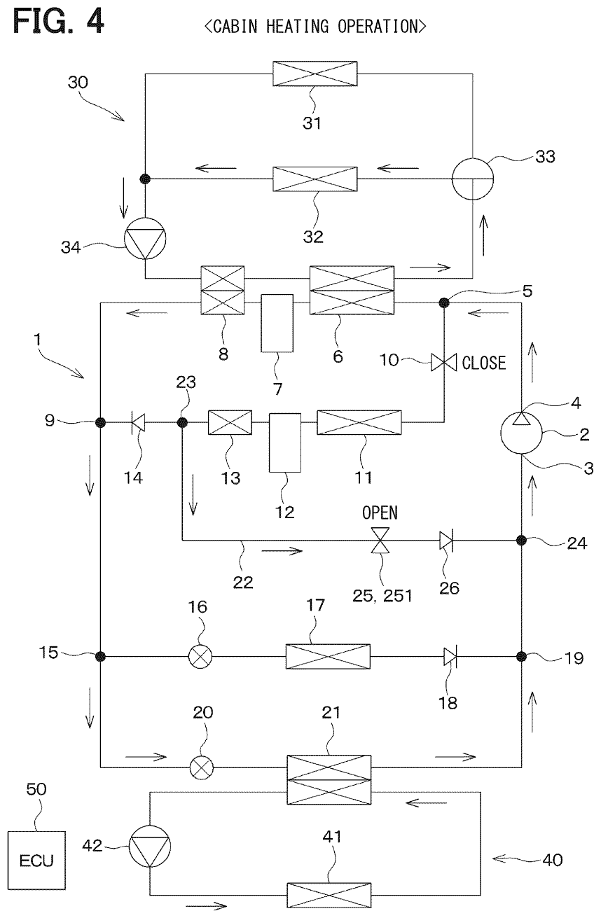

In cabin heating operation, the flow of the refrigerant and the heat medium is indicated by an arrows in FIG. 4. During the cabin heating operation, the ECU 50 controls the rotational speed of the compressor 2 according to the heating load. In addition, the ECU 50 closes the air-cooling solenoid valve 10 and opens the bypass solenoid valve 251. Furthermore, the ECU 50 drives the high-temperature pump 34 and the three-way valve 33 so that the heat medium circulating in the high-temperature circuit 30 flows through the heater core 32 without passing through the radiator 31. It should be noted that when the battery cooling operation is performed together with the cabin heating operation, the ECU 50 drives the low-temperature pump 42.

As a result, as indicated by the arrows in FIG. 4, in the heat pump cycle device 1, the refrigerant discharged from the compressor 2 flows through the refrigerant flow path on the water-cooled condenser 6 side, and does not flow through the refrigerant flow path on the air-cooled condenser 11 side. At this time, the refrigerant in the refrigerant flow path on the air-cooled condenser 11 side flows to the refrigerant suction port 3 of the compressor 2 via the bypass flow path 22. In the high-temperature circuit 30, the heat medium circulates between the water-cooled condenser 6 and the heater core 32.

In this way, during the cabin heating operation, the heat pump cycle device 1 uses only the water-cooled condenser 6 and does not use the air-cooled condenser 11, thereby preventing heat loss of the high-pressure refrigerant to the outside air via the air-cooled condenser 11 and maintaining heating performance. In addition, in the high-temperature circuit 30, the heat loss to the outside air via the radiator 31 is also prevented.

The heat pump cycle device 1 of the first embodiment described above achieves the following operational effects due to its configuration. The heat pump cycle device 1 of the first embodiment has the bypass flow path 22. The bypass flow path 22 connects the refrigerant flow path from the air-cooling solenoid valve 10, through the air-cooled condenser 11, to the check valve 14 for the air-cooled condenser 11, with the refrigerant flow path from the refrigerant outlet of the evaporators 17 and 21 to the refrigerant suction port 3 of the compressor 2. Accordingly, the flow of the refrigerant from the compressor 2 to the air-cooled condenser 11 can be regulated by the air-cooling solenoid valve 10, and during operation using only the water-cooled condenser 6, the refrigerant accumulated in the air-cooled condenser 11 can be recovered to the compressor 2 via the bypass flow path 22. Therefore, during such operation, it is possible to prevent a shortage of the refrigerant and the oil circulating in the cycle. Accordingly, this heat pump cycle device 1 can improve the performance of the air conditioning, heating, and battery cooling, and furthermore, can prevent the compressor 2 from locking.

In the first embodiment, the heat pump cycle device 1 includes the air-cooling solenoid valve 10 in the middle of the refrigerant flow path connecting the first branching section 5 and the air-cooled condenser 11. Accordingly, in the heat pump cycle device 1, since the circuit configuration ensures that the water-cooled condenser 6 is always used during operation, the refrigerant and the oil do not accumulate in the water-cooled condenser 6. Therefore, since it is sufficient to provide the bypass flow path 22 only in the refrigerant flow path on the air-cooled condenser 11 side, the heat pump cycle device 1 can have a simplified configuration.

In the first embodiment, the heat pump cycle device 1 includes the check valve 14 for the air-cooled condenser 11 in the middle of the refrigerant flow path connecting the air-cooled condenser 11 and the first merging section 9. As a result, the refrigerant can be prevented from flowing from the refrigerant flow path on the water-cooled condenser 6 side to the bypass flow path 22 via the first merging section 9.

In the first embodiment, the heat pump cycle device 1 includes the flow control unit 25 that controls the flow of refrigerant in the bypass flow path 22. Accordingly, the flow of refrigerant from the bypass flow path 22 to the compressor 2 can be controlled.

In the first embodiment, the flow control unit 25 provided in the bypass flow path 22 is the bypass solenoid valve 251. Accordingly, when the air-cooled condenser 11 is used, the bypass solenoid valve 251 can be closed to restrict the flow of refrigerant in the bypass flow path 22. On the other hand, when the air-cooled condenser 11 is not used, the bypass solenoid valve 251 can be opened to recover the refrigerant from the air-cooled condenser 11 to the compressor 2.

The heat pump cycle device 1 of the first embodiment includes the first liquid receiver 7 and the second liquid receiver 12. The first liquid receiver 7 is provided in the middle of the refrigerant flow path connecting the water-cooled condenser 6 and the first merging section 9, and the second liquid receiver 12 is provided in the middle of the refrigerant flow path connecting the air-cooled condenser 11 and the check valve 14 for the air-cooled condenser 11. Incidentally, in general, when the refrigerant flow rate is high, the liquid receiver may exhibit reduced gas-liquid separation performance. In contrast, in this heat pump cycle device 1, when both the air-cooled condenser 11 and the water-cooled condenser 6 are used, the refrigerant flow rate passing through each of the first liquid receiver 7 and the second liquid receiver 12 decreases, thereby preventing deterioration in the gas-liquid separation performance of the liquid receivers.

In the first embodiment, the maximum storage capacity of the second liquid receiver 12 is equal to or less than the maximum storage capacity of the first liquid receiver 7. According to this, since the water-cooled condenser 6 is used at all times and the air-cooled condenser 11 is used only when necessary, it is preferable to enable the refrigerant used on the air-cooled condenser 11 side to be retained in the first liquid receiver 7. On the other hand, since the air-cooled condenser 11 is used together with the water-cooled condenser 6, the capacity of the second liquid receiver 12 can be relatively small. Therefore, a size of the second liquid receiver 12 can be reduced.

The heat pump cycle device 1 of the first embodiment includes the first subcooler 8 and the second subcooler 13. The first subcooler 8 is provided in the middle of the refrigerant flow path connecting the first liquid receiver 7 and the first merging section 9, and the second subcooler 13 is provided in the middle of the refrigerant flow path connecting the second liquid receiver 12 and the check valve 14 for the air-cooled condenser. According to this, the degree of subcooling of the refrigerant can be increased, and the cooling performance and refrigeration performance using the evaporators 17 and 21 can be greatly improved.

In the first embodiment, the pressure loss of the refrigerant flowing through the air-cooled flow path is smaller than the pressure loss of the refrigerant flowing through the water-cooled flow path. According to this, since the water-cooled condenser 6 exchanges heat between the refrigerant and the heat medium, and then the heat medium exchanges heat with the air via the radiator 31, it generally tends to have lower heat dissipation performance for the refrigerant compared to the air-cooled condenser 11. Therefore, the pressure loss in the air-cooled flow path is made smaller than the pressure loss in the water-cooled flow path. As a result, when both the air-cooled condenser 11 and the water-cooled condenser 6 are used, it becomes possible to increase the refrigerant flow rate on the air-cooled condenser 11 side compared to the refrigerant flow rate on the water-cooled condenser 6 side. Therefore, when both the air-cooled condenser 11 and the water-cooled condenser 6 are used, a greater amount of heat dissipation can be achieved, resulting in higher cooling and refrigeration performance.

In the first embodiment, when performing at least one of the cabin cooling operation and the battery cooling operation, the ECU 50 opens the air cooling solenoid valve 10 and controls the system so that the refrigerant flows to both the air-cooled condenser 11 and the water-cooled condenser 6. Accordingly, when at least one of the cabin cooling operation and the battery cooling operation is performed, using both the air-cooled condenser 11 and the water-cooled condenser 6 increases the heat dissipation of the high-pressure refrigerant, thereby significantly improving cooling and refrigeration performance. In addition, since the water-cooled condenser 6 is connected to the air-cooled condenser 11 in parallel, the heat dissipation of the high-pressure refrigerant is increased, thereby greatly improving cooling and refrigeration performance.

In the first embodiment, when the load of the cabin cooling operation or the load of the battery cooling operation exceeds a predetermined value, the ECU 50 opens the air cooling solenoid valve 10 and controls the system so that the refrigerant flows to both the air-cooled condenser 11 and the water-cooled condenser 6. Accordingly, when the load of the cabin cooling operation or the load of the battery cooling operation exceeds the predetermined value, using both the air-cooled condenser 11 and the water-cooled condenser 6 increases the heat dissipation of the high-pressure refrigerant, thereby greatly improving cooling and refrigeration performance. In addition, by connecting the water-cooled condenser 6 and the air-cooled condenser 11 in parallel, this heat pump cycle device 1 increases the heat dissipation of the high-pressure refrigerant, thereby greatly improving the cooling and refrigeration performance using the evaporators 17 and 21.

In the first embodiment, when performing the cabin heating operation, the ECU 50 closes the air cooling solenoid valve 10 to restrict the flow of refrigerant to the air-cooled condenser 11, and controls the system so that the refrigerant flows to the water-cooled condenser 6. Accordingly, during the cabin heating operation, the heat loss from the high-pressure refrigerant to the outside air via the air-cooled condenser 11 can be prevented, thereby maintaining the heating performance.

In the first embodiment, when the load of the cabin cooling operation and the battery cooling operation is less than a predetermined value, or when performing the cabin heating operation, the ECU 50 closes the air cooling solenoid valve 10 to restrict the flow of refrigerant to the air-cooled condenser 11, and controls the system so that the refrigerant flows to the water-cooled condenser 6. Accordingly, when the load of the cabin cooling operation and the battery cooling operation is less than the predetermined value, only the water-cooled condenser 6 is used and the air-cooled condenser 11 is not used, thereby enabling the compressor 2 to operate with reduced power consumption. In addition, when performing the cabin heating operation, the heat loss from the high-pressure refrigerant to the outside air via the air-cooled condenser 11 can be prevented, thereby maintaining the heating performance.

The heat pump cycle device 1 of the first embodiment includes the check valve 26 installed midway along the bypass flow path 22. As a result, backflow of the refrigerant from the suction port 3 side of the compressor 2 to the air-cooled condenser 11 side can be prevented.

### Second Embodiment

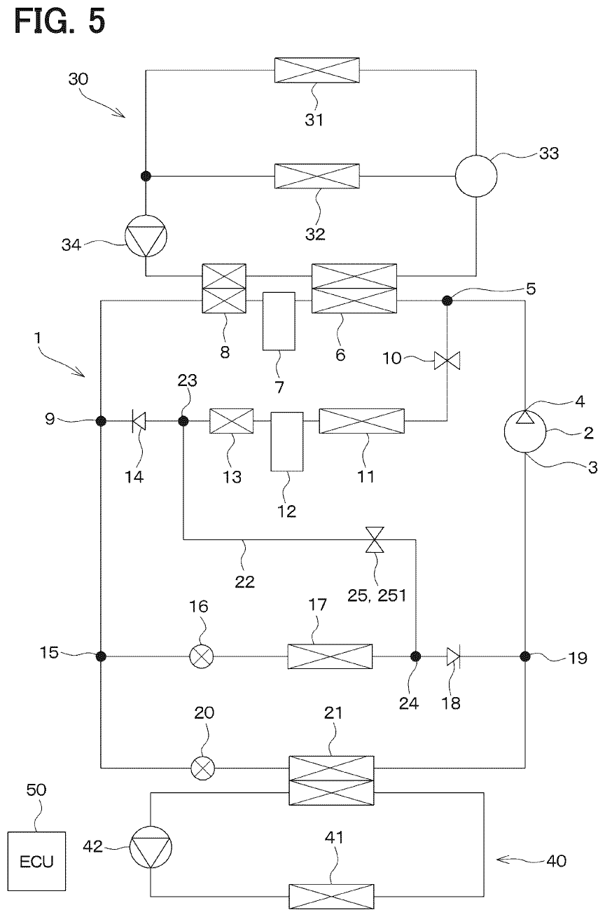

A second embodiment will be described with reference to FIG. 5. The second embodiment differs from the first embodiment in that a part of a configuration of a bypass flow path 22 has been changed, while the other aspects are the same as those of the first embodiment. Therefore, only the differences from the first embodiment will be described.

As shown in FIG. 5, in the second embodiment, a connection point of the bypass flow path 22 differs from that of the first embodiment. More specifically, one end 23 of the bypass flow path 22 is connected, as in the first embodiment, to an intermediate point in the refrigerant flow path that runs from the air-cooling solenoid valve 10 through the air-cooled condenser 11 to the check valve 14 for the air-cooled condenser. On the other hand, in the second embodiment, the other end 24 of the bypass flow path 22 is connected to an intermediate point in the refrigerant flow path that connects the air conditioning evaporator 17 and the check valve 18 for the evaporator 17.

The check valve 18 allows the flow of refrigerant from the air conditioning evaporator 17 side toward the refrigerant suction port 3 side of the compressor 2, and restricts the flow of refrigerant from the refrigerant suction port 3 side of the compressor 2 toward the air conditioning evaporator 17 side. Furthermore, the check valve 18 in the second embodiment allows the flow of refrigerant from the bypass flow path 22 side toward the refrigerant suction port 3 side of the compressor 2, and is capable of restricting the flow of refrigerant from the refrigerant suction port 3 side of the compressor 2 toward the bypass flow path 22 side. Therefore, in the second embodiment, the bypass flow path 22 is not provided with the check valve 26 described in the first embodiment.

The heat pump cycle device 1 of the second embodiment described above can also achieve the same operational effects as the first embodiment. Furthermore, in the second embodiment, compared to the first embodiment, it is possible to reduce the number of check valves, thereby decreasing the number of components.

### Third Embodiment

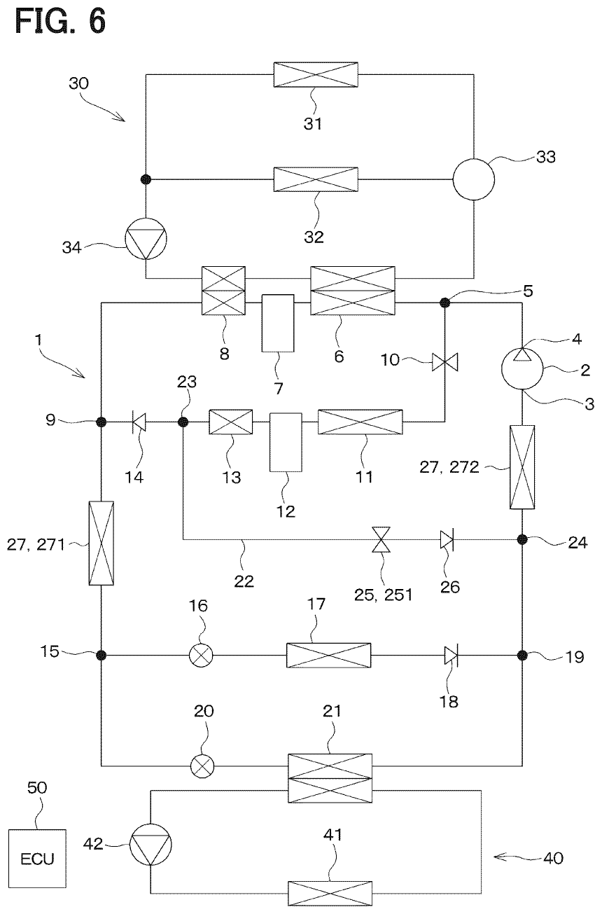

A third embodiment will be described with reference to FIG. 6. The third embodiment is obtained by adding an internal heat exchanger 27 to the first embodiment, and is otherwise the same as the first embodiment. Therefore, only the differences from the first embodiment will be described.

As shown in FIG. 6, a heat pump cycle device 1 of the third embodiment includes the internal heat exchanger 27. The internal heat exchanger 27 is a heat exchanger that exchanges heat between the high-pressure refrigerant discharged from the first subcooler 8 and the second subcooler 13, and the low-pressure refrigerant discharged from the air conditioning evaporator 17 and the battery evaporator 21. In the third embodiment, a first section 271 of the internal heat exchanger 27, through which the high-pressure refrigerant flows, is provided in a middle part of the refrigerant flow path connecting the first merging section 9 and the second branching section 15. A second section 272 of the internal heat exchanger 27, through which the low-pressure refrigerant flows, is provided in a middle part of the refrigerant flow path connecting the second merging section 19 and the refrigerant suction port 3 of the compressor 2. More specifically, the second section 272 of the internal heat exchanger 27, through which the low-pressure refrigerant flows, is provided in the middle part of the refrigerant flow path connecting the other end 24 of the bypass flow path 22 and the refrigerant suction port 3 of the compressor 2.

It should be noted that, in FIG. 6, for the sake of convenience in explanation, the first section 271 of the internal heat exchanger 27, through which the high-pressure refrigerant flows, and the second section 272 of the internal heat exchanger 27, through which the low-pressure refrigerant flows, are depicted at separate locations; however, in actuality, the internal heat exchanger 27 is configured such that these sections are integrated into a single unit. This also applies to various modifications of the third embodiment described later.

The heat pump cycle device 1 of the third embodiment described above can also achieve the same effects as those of the first embodiment. Furthermore, by including the internal heat exchanger 27, the heat pump cycle device 1 of the third embodiment can increase the degree of subcooling of the refrigerant flowing into the evaporators 17 and 21, thereby further improving the air conditioning performance for the vehicle compartment and the battery cooling performance.

### First Modification of Third Embodiment

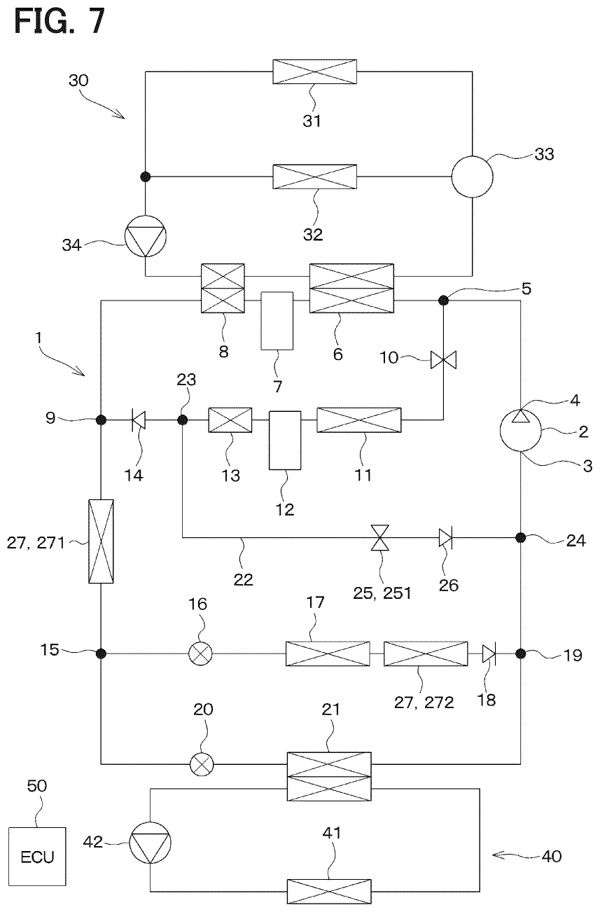

A first modification of the third embodiment will be described with reference to FIG. 7. In the first modification of the third embodiment, a location where the second section 272 of the internal heat exchanger 27, through which the low-pressure refrigerant flows, is provided differs from that in the third embodiment.

As shown in FIG. 7, in the first modification of the third embodiment, the second section 272 of the internal heat exchanger 27, through which the low-pressure refrigerant flows, is provided in a middle part of the refrigerant flow path connecting the air conditioning evaporator 17 and the second merging section 19. More specifically, the second section 272 of the internal heat exchanger 27, through which the low-pressure refrigerant flows, is provided in the middle part of the refrigerant flow path connecting the air conditioning evaporator 17 and the check valve 18.

The first modification of the third embodiment described above can also achieve the same effects as those of the third embodiment.

### Second Modification of Third Embodiment

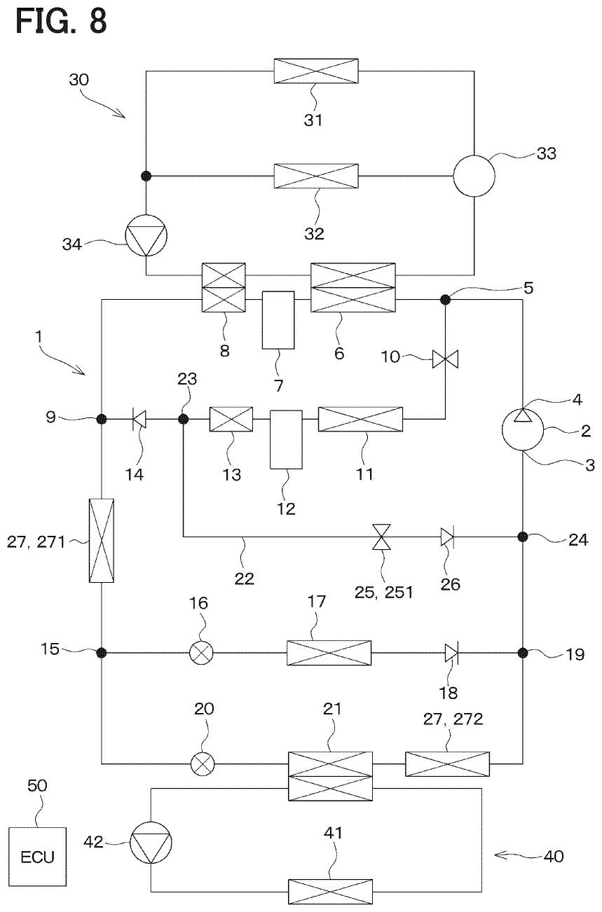

A second modification of the third embodiment will be described with reference to FIG. 8. In the second modification of the third embodiment as well, a location where the second section 272 of the internal heat exchanger 27, through which the low-pressure refrigerant flows, is provided differs from that in the third embodiment.

As shown in FIG. 8, in the second modification of the third embodiment, the second section 272 of the internal heat exchanger 27, through which the low-pressure refrigerant flows, is provided in a middle part of the refrigerant flow path connecting the battery evaporator 21 and the second merging section 19.

The second modification of the third embodiment described above can also achieve the same effects as those of the third embodiment.

### Fourth Embodiment

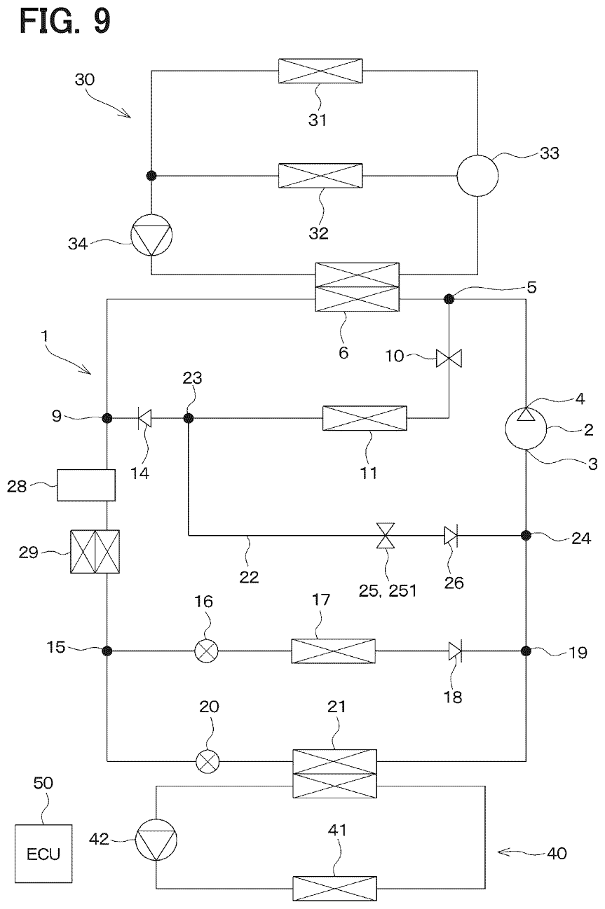

A fourth embodiment will be described with reference to FIG. 9. The fourth embodiment differs from the first embodiment in a configuration of a liquid receiver and a subcooler, while other aspects are the same as in the first embodiment. Therefore, only the differences from the first embodiment will be described.

As shown in FIG. 9, in the fourth embodiment, the liquid receiver 28 and the subcooler 29 are provided in a middle part of the refrigerant flow path connecting the first merging section 9 and the second branching section 15. The liquid receiver 28 separates the refrigerant flowing in from the water-cooled condenser 6 and the air-cooled condenser 11 into a gas-phase refrigerant and a liquid-phase refrigerant, and allows only the liquid-phase refrigerant to flow downstream. The subcooler 29 is a heat exchanger that exchanges heat between the refrigerant discharged from the liquid receiver 28 and the heat medium circulating through the heat medium circuit. The subcooler 29 increases the degree of subcooling of the refrigerant and heats the heat medium.

It should be noted that the heat pump cycle device 1 of the fourth embodiment does not include the first liquid receiver 7, the second liquid receiver 12, the first subcooler 8, or the second subcooler 13 described in the first embodiment.

The heat pump cycle device 1 of the fourth embodiment described above can also achieve the same effects and advantages as those of the first embodiment. Furthermore, in the fourth embodiment, compared to the first embodiment, it is possible to reduce the number of liquid receivers and subcoolers, thereby reducing the number of components.

It should be noted that, as a modification of the fourth embodiment, the subcooler 29 may be configured as a heat exchanger that exchanges heat between the refrigerant and air.

### Fifth Embodiment

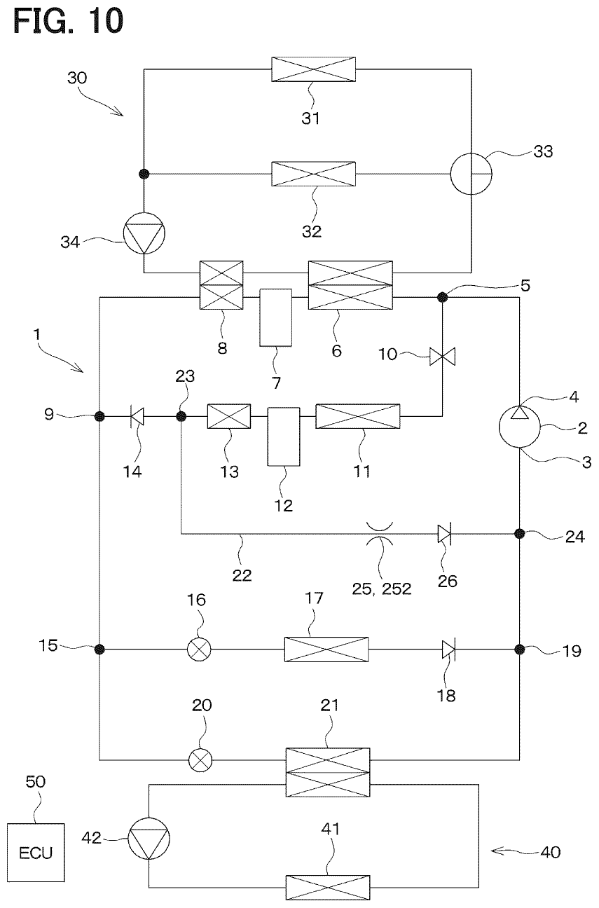

A fifth embodiment will be described with reference to FIG. 10. The fifth embodiment differs from the first embodiment in that a configuration of a flow control unit 25 provided in a bypass flow path 22 has been changed, and the other aspects are the same as in the first embodiment. Therefore, only the parts that differ from the first embodiment will be described.

As shown in FIG. 10, in the fifth embodiment, the flow control unit 25 provided in the bypass flow path 22 is configured as a bleed port 252 instead of the bypass solenoid valve 251 described in the first embodiment. The bleed port 252 is constituted by an orifice having a relatively small opening area, set so as to allow control of the flow rate of refrigerant flowing from the bypass flow path 22 to the compressor 2. The opening area of the bleed port 252 is set so as to minimize its impact when the air-cooled condenser 11 is in use.

In the fifth embodiment described above, the flow control unit 25 provided in the bypass flow path 22 can be configured with a simple structure.

### Other Embodiments

In the above embodiments, the refrigerant circulating in the heat pump cycle device 1 has been described as an HFO-based refrigerant or an HFC-based refrigerant; however, the invention is not limited to these, and a natural refrigerant such as carbon dioxide may also be used, for example.

In the above embodiments, the heat medium circulating in the heat medium circuit has been described as water or antifreeze. However, the invention is not limited to these, and various fluids such as oil may also be used, for example.

In each of the above embodiments, the first valve 10 is configured as a solenoid valve. However, the invention is not limited to this, and for example, the first branching section 5 and the first valve 10 may be configured as a three-way valve. In that case, the first branching section 5 is formed in an internal flow passage of the three-way valve.

In the above embodiments, the second valve 14 is configured as a check valve. However, the invention is not limited to this, and for example, the first merging section 9 and the second valve 14 may be configured as a three-way valve. In that case, the first merging section 9 is formed in an internal flow passage of the three-way valve.

In the above embodiments, the flow control unit 25 is provided in the bypass flow path 22. However, the invention is not limited to this, and for example, a cross-sectional area of the bypass flow path 22 may be reduced.

In the above embodiments, the heat pump cycle device 1 is described as being equipped with the first expansion valve 16, the second expansion valve 20, the air conditioning evaporator 17, and the battery evaporator 21. However, the invention is not limited to this configuration. For example, the heat pump cycle device 1 may be configured to include the first expansion valve 16 and the air conditioning evaporator 17, without including the second expansion valve 20 and the battery evaporator 21. Alternatively, the heat pump cycle device 1 may be configured to include the second expansion valve 20 and the battery evaporator 21, without including the first expansion valve 16 and the air conditioning evaporator 17.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

The control unit and the method thereof described in the present disclosure are realized by a dedicated computer provided by configuring a processor and a memory programmed to execute one or more functions embodied by a computer program. May be done. Alternatively, the controller and the method described in the present disclosure may be implemented by a special purpose computer configured as a processor with one or more special purpose hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The memory is a non-transitory tangible storage medium. By executing this computer program, a method corresponding to the computer program is performed.

What is claimed is:

1. A heat pump cycle device comprising:
a compressor compressing a refrigerant;
a first condenser condensing the refrigerant discharged from the compressor by heat exchange between the refrigerant and a heat medium;
a second condenser connected in parallel with the first condenser and condensing the refrigerant discharged from the compressor by heat exchange between the refrigerant and air;
a first valve permitting and restricting a flow of the refrigerant from a branching section to the second condenser, the branching section at which the refrigerant discharged from the compressor is divided into a refrigerant flow path located upstream of the first condenser and a refrigerant flow path located upstream of the second condenser;
a second valve restricting a flow of the refrigerant from a merging section to the second condenser, the merging section at which a refrigerant flow path located downstream of the first condenser and a refrigerant flow path located downstream of the second condenser merge;
an expansion valve provided downstream of the merging section and decompressing and expanding the refrigerant supplied from the merging section;
an evaporator evaporating the refrigerant discharged from the expansion valve by heat exchange between the refrigerant and the air or the heat medium; and
a bypass flow path connecting a refrigerant flow path from the first valve through the second condenser to the second valve, and a refrigerant flow path from a refrigerant outlet port of the evaporator to a refrigerant suction port of the compressor, and recovering the refrigerant and oil from the second condenser to the refrigerant suction port of the compressor.

2. The heat pump cycle device according to claim 1, wherein
the first valve is a first solenoid valve provided in a refrigerant flow path connecting the branching section and the second condenser.

3. The heat pump cycle device according to claim 1, wherein
the second valve is a first check valve provided in a refrigerant flow path connecting the second condenser and the merging section.

4. The heat pump cycle device according to claim 1, further comprising:
a flow control unit configured to control a flow of the refrigerant and oil in the bypass flow path.

5. The heat pump cycle device according to claim 4, wherein
the flow control unit is a second solenoid valve permitting and restricting a flow of the refrigerant and the oil from the bypass flow path to the refrigerant suction port of the compressor.

6. The heat pump cycle device according to claim 4, wherein
the flow control unit is a bleed port configured to control a flow rate of the refrigerant and the oil flowing from the bypass flow path to the refrigerant suction port of the compressor.

7. The heat pump cycle device according to claim 1, further comprising:
a first liquid receiver provided in a refrigerant flow path connecting the first condenser and the merging section; and
a second liquid receiver provided in a refrigerant flow path connecting the second condenser and the second valve, wherein
a maximum storage amount of the second liquid receiver is equal to or less than a maximum storage amount of the first liquid receiver.

8. The heat pump cycle device according to claim 7, further comprising:
a first subcooler provided in a refrigerant flow path connecting the first liquid receiver and the merging section, and performing heat exchange between the refrigerant discharged from the first liquid receiver and the heat medium; and
a second subcooler provided in a refrigerant flow path connecting the second liquid receiver and the second valve, and performing heat exchange between the refrigerant discharged from the second liquid receiver and the air.

9. The heat pump cycle device according to claim 1, further comprising:
a liquid receiver provided in a refrigerant flow path connecting the merging section and the expansion valve; and
a subcooler provided in a refrigerant flow path connecting the liquid receiver and the expansion valve, and performing heat exchange between the refrigerant discharged from the liquid receiver and the heat medium or the air.

10. The heat pump cycle device according to claim 1, further comprising:
a radiator performing heat exchange between the air and the heat medium, wherein
the radiator is provided in a heat medium circuit supplying the heat medium to the first condenser, and
a pressure loss of the refrigerant from the branching section through the second condenser to the merging section is smaller than a pressure loss of the refrigerant from the branching section through the first condenser to the merging section.

11. The heat pump cycle device according to claim 1, further comprising:
a radiator performing heat exchange between the air and the heat medium; and
at least one of (i) a circuit and (ii) a processor with a memory storing computer program code executable by the processor configured to control the first valve, wherein
the radiator is provided in a heat medium circuit supplying the heat medium to the first condenser,
the evaporator includes a first evaporator used for air conditioning operation in a vehicle compartment and a second evaporator used for battery cooling operation, and
the at least one of the circuit and the processor is configured to control the first valve to allow the refrigerant to flow to both the second condenser and the first condenser when at least one of the air conditioning operation and the battery cooling operation is performed.

12. The heat pump cycle device according to claim 11, wherein
the at least one of the circuit and the processor is configured to control the first valve to allow the refrigerant to flow to both the second condenser and the first condenser when a load of the air conditioning operation or a load of the battery cooling operation exceeds a predetermined load amount.

13. The heat pump cycle device according to claim 11, further comprising:
a heater core performing heat exchange between the air blown into the vehicle compartment and the heat medium, wherein
the heater core is provided in a heat medium circuit supplying the heat medium to the first condenser, and
the at least one of the circuit and the processor is configured to control the first valve to restrict a flow of the refrigerant to the second condenser and to allow the refrigerant to flow to the first condenser when heating operation in the vehicle compartment is performed.

14. The heat pump cycle device according to claim 11, further comprising:
a heater core performing heat exchange between the air blown into the vehicle compartment and the heat medium, wherein
the heater core is provided in a heat medium circuit supplying the heat medium to the first condenser, and
the at least one of the circuit and the processor is configured to control the first valve to restrict a flow of the refrigerant to the second condenser and to allow the refrigerant to flow to the first condenser when each of a load of the air conditioning operation and a load of the battery cooling operation is less than a predetermined load amount or when heating operation is performed.

15. The heat pump cycle device according to claim 1, further comprising:
a second check valve provided in the bypass flow path, wherein
the second check valve permits a flow of the refrigerant from the second condenser to the refrigerant suction port of the compressor and restricts a flow of the refrigerant from the refrigerant suction port of the compressor to the second condenser.

16. The heat pump cycle device according to claim 1, further comprising:
a third check valve provided in a refrigerant flow path connecting a refrigerant outlet port of the evaporator and the refrigerant suction port of the compressor, wherein
the third check valve permits a flow of the refrigerant from the evaporator to the refrigerant suction port of the compressor and restricts a flow of the refrigerant from the refrigerant suction port of the compressor to the evaporator,
one end of the bypass flow path is connected to the refrigerant flow path from the first valve through the second condenser to the second valve, and
the other end of the bypass flow path is connected to a refrigerant flow path connecting the refrigerant outlet port of the evaporator and the third check valve.

17. The heat pump cycle device according to claim 1, further comprising:
an internal heat exchanger performing heat exchange between the refrigerant flowing between the merging section and the expansion valve and the refrigerant flowing between the refrigerant outlet port of the evaporator and the refrigerant suction port of the compressor.
